(19) United States
(12) Patent Application Publication
(10) Pub. No.: US 2016/0254780 A1
(43) Pub. Date: Sep. 1, 2016

(54) Power Conversion Apparatus and Photovoltaic System

(71) Applicant: Hitachi, Ltd., Tokyo (JP)

(72) Inventors: Tomomichi ITO, Tokyo (JP); Hideaki KUNISADA, Tokyo (JP); Kaoru SONOBE, Tokyo (JP); Hirotaka NISHIZAWA, Tokyo (JP); Yoshiro NAKAJIMA, Tokyo (JP); Tamaki WADA, Tokyo (JP)

(21) Appl. No.: 15/048,150

(22) Filed: Feb. 19, 2016

(30) Foreign Application Priority Data
Feb. 27, 2015 (JP) 2015-037618

(51) Int. Cl. H02S 40/12; H02S 40/44; H02S 40/32

(52) U.S. Cl. CPC H02S 40/12; H02S 40/32; H02S 40/44

(57) ABSTRACT

A power conversion apparatus that is connected between a solar panel and a power system, in which the power conversion apparatus includes a power generating mode that converts a generated power of the solar panel into an alternating current power, and a snow melting mode that heats the solar panel by obtaining the power from the power system, and supplying the power to the solar panel, and at the time of the snow melting mode, the power conversion apparatus controls a voltage which is output to the solar panel such that a first current value being a value where a current that is supplied to the solar panel from the power conversion apparatus is smaller than an overcurrent level of the solar panel flows in a predetermined period.

### BACKGROUND OF THE INVENTION

1. Field of the Invention

The present invention relates to a power conversion apparatus and a photovoltaic system.

2. Background Art

In recent years, a photovoltaic system where solar panels and a power system are interconnected through an inverter, has been widely used. Since the solar panel obtains the generated power by solar radiation, a quantity of the generated power is reduced or the power generation is not possible when the solar radiation is blocked. As one of causes which block the solar radiation, there is deep snow that is accumulated on the solar panel. In order to prevent the deep snow, a study that prompts sliding down of the snow by increasing a slope angle of the panel in a deep snow region has been made. However, there is a case where the deep snow or the ice on the panel is not sufficiently slid down in spite of the above study, and the quantity of the generated power from the photovoltaic system is reduced due to the snow or the ice.

With respect to the above problems, JP-A-2000-156940 discloses a method for controlling a converter in which an inverter is constructed by a bidirectional converter, and a fixed voltage is applied to a solar panel by the converter, and the solar panel is heated and the sliding down of the snow is assisted by making a snow melting current flow to the solar panel from the converter, and the snow melting is completed when the current which is supplied from the converter exceeds a predetermined value, and the current supply to the solar panel is stopped.

### SUMMARY OF THE INVENTION

In JP-A-2000-156940, when the snow melting current is supplied by supplying the fixed voltage to the solar panel with the bidirectional converter, impedance of the solar panel is reduced by a temperature increase of the solar panel due to the electrification. By the temperature increase, if the impedance of the solar panel is reduced, a large current flows through the solar panel, and the bidirectional converter stops the current supply for the snow melting before a heat quantity which is necessary for the snow melting is supplied. In order to supply the sufficient heat quantity, a current value for determining the snow melting completion is necessarily set to be excessive, and there is a concern to damage the solar panel due to an overcurrent.

The present invention provides a photovoltaic system, and a power conversion apparatus that are capable of supplying a snow melting current which may supply a sufficient heat quantity to a solar panel while preventing an overcurrent of the solar panel.

In order to solve the above problems, according to an aspect of the present invention, there is provided a power conversion apparatus which is connected between a solar panel and a power system, including a power generating mode that converts a generated power of the solar panel into an alternating current power, and a snow melting mode that heats the solar panel by obtaining the power from the power system, and supplying the power to the solar panel, in which at the time of the snow melting mode, a voltage which is output to the solar panel is controlled such that a first current value being a value where a current that is supplied to the solar panel from the power conversion apparatus is smaller than an overcurrent level of the solar panel flows in a predetermined period.

According to the present invention, a photovoltaic system, and the power conversion apparatus that are capable of supplying a snow melting current which may supply a sufficient heat quantity to the solar panel while preventing the overcurrent of the solar panel are provided.

### BRIEF DESCRIPTION OF THE DRAWINGS

FIG. 1 is a configuration view of a photovoltaic system in a first embodiment.

FIG. 2 is a configuration view of a main circuit of a solar inverter in the first embodiment.

FIG. 3 is a block diagram of a controller of the solar inverter in the first embodiment.

FIG. 4 is a block diagram of a synchronous phase signal calculation portion in the first embodiment.

FIG. 5 is a block diagram of a direct current control portion of the solar inverter in the first embodiment.

FIG. 6 is a view for illustrating current-voltage characteristics of a solar panel, and an operation point of the solar inverter in the first embodiment.

FIG. 7 is a time chart of the solar inverter in the first embodiment.

FIG. 8 is an overview of a photovoltaic system in a second embodiment.

FIG. 9 is an overview of the photovoltaic system in the second embodiment.

FIG. 10 is an overview of a photovoltaic system in a third embodiment.

FIG. 11 is a configuration view of a main circuit of a power conversion portion of a solar inverter in the third embodiment.

FIG. 12 is a calculation block diagram of a controller of the solar inverter in the third embodiment.

FIG. 13 is a time chart of the solar inverter in the third embodiment.

FIG. 14 is a time chart in a case where a fixed voltage is supplied to the solar panel.

### DETAILED DESCRIPTION OF THE INVENTION

Hereinafter, embodiments will be described by using the drawings.

### First Embodiment

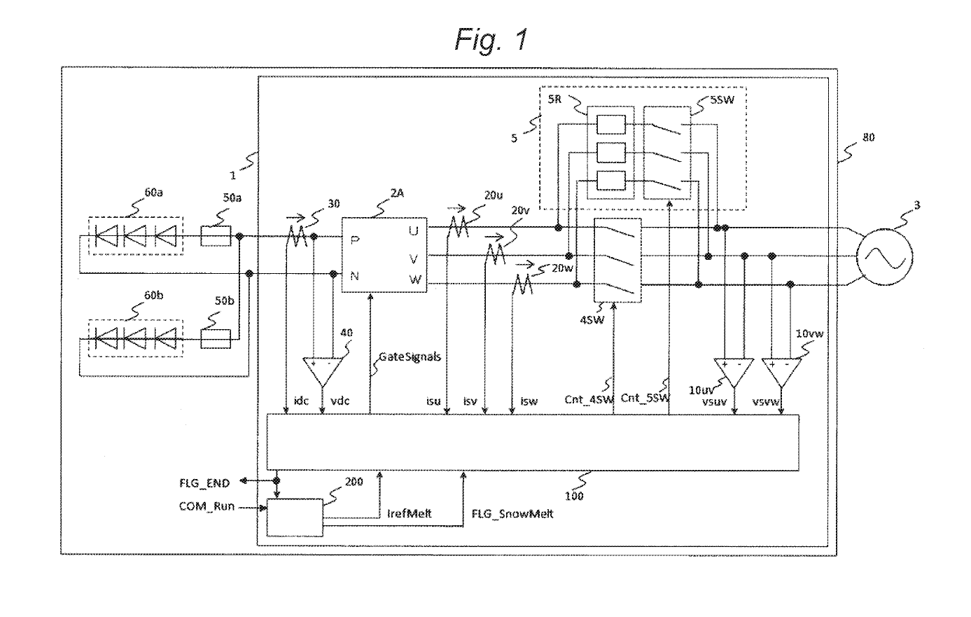

FIG. 1 is a configuration view of a photovoltaic system in a first embodiment.

A photovoltaic system 80 according to the first embodiment of the present invention, is configured by strings 60a and 60b where a plurality of solar panels are connected in series, string protection fuses 50a and 50b, and a solar inverter 1. The strings 60a and 60b are connected to a direct current terminal of the solar inverter 1 through the string protection fuses 50a and 50b. Therefore, an alternating current terminal of the solar inverter 1 is connected to a power system 3. The solar inverter 1 has a function of controlling the power which is delivered between the strings 60a and 60b and the power system 3.

The photovoltaic system 80 of the first embodiment, has two control modes. One is a power generating mode that transmits the power to the power system 3 by converting the direct current power which is obtained from the strings 60a and 60b being the solar panels into the alternating current power with the solar inverter 1. The other is a snow melting mode that receives the alternating current power from the power system 3, supplies the power to the strings 60a and 60b by converting the alternating current power into the direct current power with the solar inverter 1, and increases a temperature of the solar panel.

By the two modes, in a state of being with solar radiation, the power generating mode that carries out a power generating run by controlling the solar inverter 1 is executed, and at the time of deep snow, the snow melting mode that carries out a snow melting run of the snow on the solar panel by controlling the solar inverter 1 is executed.

Hereinafter, the configuration of the solar inverter 1 will be described while using FIG. 1.

The solar inverter 1 is configured by a power conversion portion 2A, a contactor 4SW, a precharging circuit 5, voltage sensors 10uv, 10vw, and 40, current sensors 20u, 20v, 20w, and 30, a controller 100, and a human interface circuit 200. The power conversion portion 2A, the contactor 4SW, a contactor 5SW within the precharging circuit 5 are controlled by a control signal from the controller 100.

Direct current terminals P and N of the power conversion portion 2A are connected to the strings 60a and 60b through the fuses 50a and 50b. Alternating current terminals U, V and W of the power conversion portion 2A are connected to the power system 3 through the precharging circuit 5 and the contactor 4SW. The alternating current which is output from the power conversion portion 2A is detected by the current sensors 20u, 20v and 20w, and a system voltage is detected by the voltage sensors 10uv and 10vw. The direct current which is input to the power conversion portion 2A is detected by the current sensor 30, and a direct current voltage is detected by the voltage sensor 40.

In the controller 100, in addition to detection signals of the voltage sensors and the current sensors, a current command IrefMelt at the time of the snow melting mode being a signal from the human interface circuit 200, and a snow melting run valid flag FLG_SnowMelt are input. Depending on the sensed values, IrefMelt, FLG_SnowMelt, gate signals GateSignals of the power conversion portion 2A, and control signals Cnt_4SW and Cnt_5SW of the contactors 4SW and 5SW are output. For example, the human interface circuit is assumed to be a liquid crystal display operation panel which is installed in a door of the solar inverter.

Here, IrefMelt and the snow melting run valid flag FLG_SnowMelt which are output to the controller 100 from the human interface circuit 200, are variables that may be changed by an operating person. When the snow melting run is set by the operating person, FLG_SnowMelt is set to be 1, and when a normal run is carried out, FLG_SnowMelt is set to be 0. Furthermore, it is preferable to set IrefMelt such that the current flowing through the solar panel is equal to or smaller than a rated current of the panel.

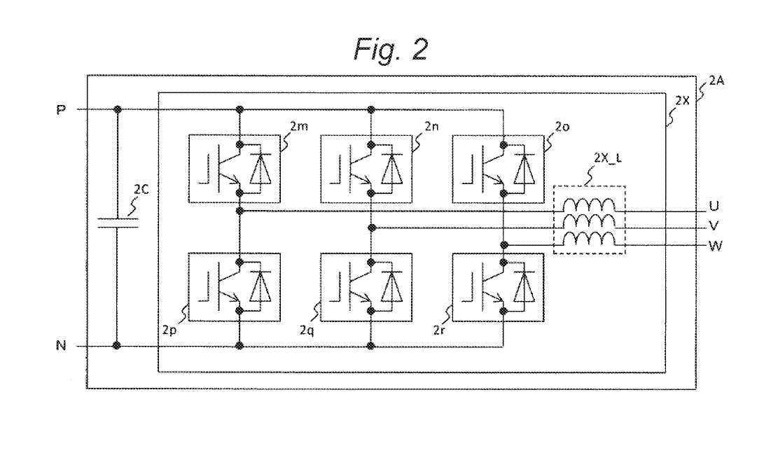

The configuration of the power conversion portion 2A will be described by using FIG. 2.

FIG. 2 is a configuration view of a main circuit of the solar inverter in the first embodiment.

The power conversion portion 2A includes an inverter 2X, and a direct current capacitor 2C. The inverter 2X is configured by IGBT modules 2m, 2n, 2o, 2p, 2q, and 2r that are configured by IGBT, and a diode which is connected to IGBT in inverse-parallel, and an alternating current reactor 2X_L. The IGBT modules are switched by the gate signals GateSignals which are output from the controller 100, and thereby, the IGBT modules realize the power conversion of direct current-alternating current and alternating current-direct current between the strings 60a and 60b and the power system 3.

The direct current capacitor 2C is connected between the direct current terminals P and N, and a voltage of a direct current circuit is smoothed.

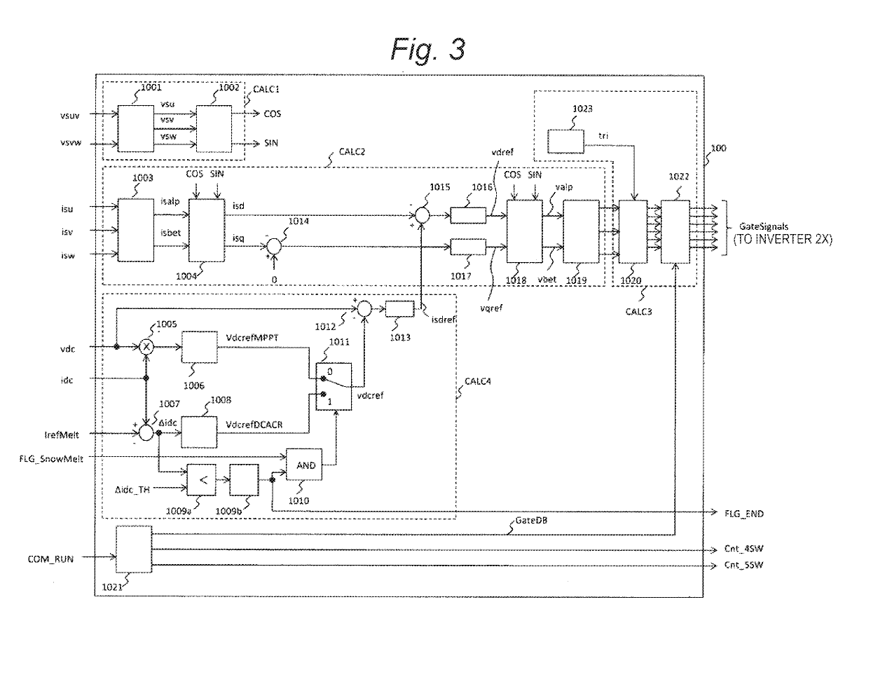

Next, the configuration of the calculation portion of the controller 100 will be described by using FIG. 3.

FIG. 3 is a block diagram of the controller 100 of the solar inverter 1 in the first embodiment.

The controller 100 is configured by a synchronous phase signal calculation portion CALC1 that calculates a sine wave in synchronization with an interconnection point voltage phase of an interconnection point being a connection point of the solar inverter 1 and the power system 3, an alternating current control calculation portion CALC2 that calculates an alternating current voltage command value for controlling an output alternating current of the solar inverter 1, an inverter gate signal calculation portion CALC3 that calculates the gate signal GateSingals by PWM-modulating the alternating current voltage command value which is calculated by CALC2, a direct current voltage control calculation portion CALC4 that calculates the command value of the active current which is output to the alternating current side of the solar inverter 1, and a system control portion 1021 that calculates the operation signals Cnt_4SW and Cnt_5SW of the contactors 4SW and 5SW, and a gate signal permission signal GateDB, based on a run command COM_Run that is input from a high order control apparatus which is not illustrated in the drawing. Here, the above control apparatus is assumed to be a remote apparatus in a case where the photovoltaic system is remotely operated.

The synchronous phase signal calculation portion CALC1 is configured by a phase voltage calculation portion 1001 and a synchronous phase signal calculation portion 1002.

Voltage detection signals Vsuv and Vsvw which are detected by the voltage sensors 10uv and 10vw, are input to the phase voltage calculation portion 1001. The phase voltage calculation portion 1001 calculates a phase voltage in accordance with Equation 1.

$$\{ \begin{matrix}vsu = \frac{1}{3} ( 2 vsuv + vsvw ) \\ vsv = \frac{1}{3} ( - vsuv + vsvw ) \\ vsw = - \frac{1}{3} ( vsuv + 2 vsvw )\end{matrix} \qquad Equation 1$$

The calculated phase voltages vsu, vsv, and vsw are input to the synchronous phase signal calculation portion 1002, and the calculation portion 1002 calculates a signal COS which is in phase with fundamental component of U phase voltage of the power system 3, and a delayed signal SIN with a phase of 90 degrees, and the signals are output to the alternating current control calculation portion CALC2.

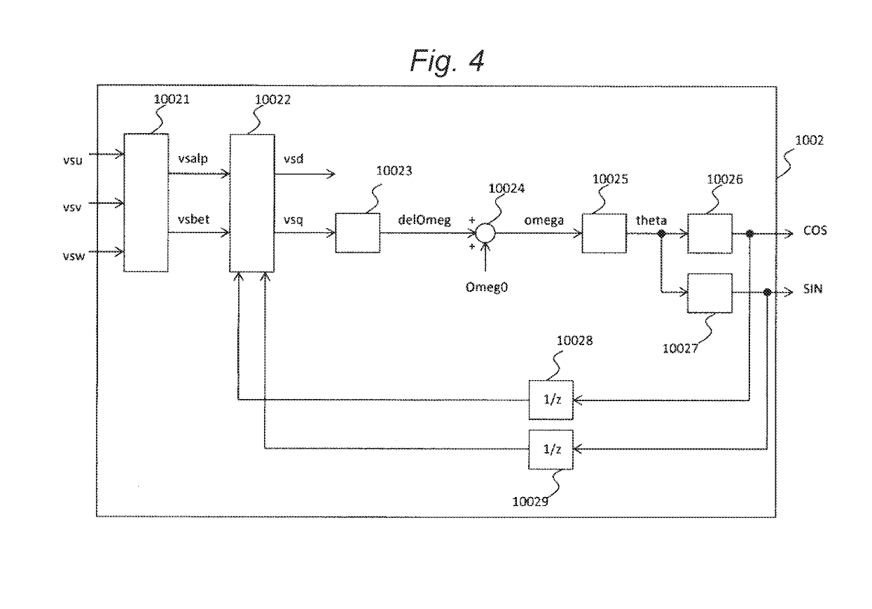

The synchronous phase signal calculation portion 1002 calculates the signals COS and SIN by a phase detection using a phase locked loop (PLL). A concrete calculation configuration of the calculation portion 1002 will be described by using FIG. 4.

FIG. 4 is a block diagram of the synchronous phase signal calculation portion in the first embodiment. The phase voltages vsu, vsv, and vsw are input to an α-β conversion portion 10021. The α-β conversion portion 10021 converts the phase voltage in an α-β manner, in accordance with Equation 2.

$$[ \begin{matrix}{vs}_{—} alp \\ {vs}_{—} bet\end{matrix} ] = \frac{2}{3} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}vsu \\ vsv \\ vsw\end{matrix} ] \qquad Equation 2$$

The α-β conversion portion 10021 outputs vs_alp being an α axis component of an interconnection point voltage, and vs_bet being a β axis component of the interconnection point voltage, to a d-q conversion portion 10022. The d-q conversion portion 10022 inputs vs_alp, vs_bet, the cos table output value COS, and the sin table calculation value SIN which are described later, and calculates a d axis component vsd and a q axis component vsq of the interconnection point voltage, in accordance with Equation 3.

$$[ \begin{matrix}vsd \\ vsq\end{matrix} ] = [ \begin{matrix}COS & SIN \\ - SIN & COS\end{matrix} ] [ \begin{matrix}{vs}_{—} alp \\ {vs}_{—} bet\end{matrix} ] \qquad Equation 3$$

The calculated q axis component vsq of the interconnection point voltage, is input to a PI control portion 10023. The PI control portion 10023 calculates a correction angle frequency delOmeg.

The correction angle frequency delOmeg and a rated angle frequency Omeg0 are added to an addition portion 10024, and omega being the sum thereof is output to a time integration portion 10025. The time integration portion 10025 calculates a phase theta of the fundamental component of the interconnection point voltage by integrating omega.

When the interconnection point voltage phase calculation value theta which is calculated on the inside of the controller, and the phase of the interconnection point voltage agree with each other, the q axis component vsq of the interconnection point voltage becomes 0. Meanwhile, when the interconnection point voltage phase calculation value theta and the interconnection point voltage phase do not agree with each other, the q axis component vsq of the interconnection point voltage becomes a nonzero value. Therefore, it is possible to detect the phase of the fundamental component of the interconnection point voltage by including the above configuration.

The phase theta of the fundamental component of the interconnection point voltage, is input to a cos table 10026 and a sin table 10027, and both of the tables calculate the signals COS and SIN responding to the phase theta. The signals COS and SIN being the output of the cos table 10026 and the sin table 10027, respectively convert the α axis component vs_alp and the β axis component vs_bet of the interconnection point voltage in a d-q manner by using the d-q conversion portion 10022, through 10028 and 10029 being delay elements.

On returning to FIG. 3, the description of the calculation of the controller 100 will be continued.

The alternating current control calculation portion CALC2 is configured by an α-β conversion portion 1003, a d-q conversion portion 1004, subtraction portions 1014 and 1015, PI control portions 1016 and 1017, an inverse d-q conversion portion 1018, and a two phases-three phases conversion portion 1019. The alternating current control calculation portion CALC2 performs a d-q coordinate conversion of the output alternating current by using the signals COS and SIN after being converted in the α-β manner, and furthermore, performs a stationary coordinate conversion of the voltage command value which is obtained on the d-q coordinate by using the signals COS and SIN, and outputs the alternating current voltage command value of three phases in the two phases-three phases conversion.

Output alternating currents isu, isv, and isw of the solar inverter 1, are input to the α-β conversion portion 1003, and the α-β conversion portion 1003 carries out the calculation in the same manner as the above-mentioned synchronous phase signal calculation portion 10021. An α axis component isalp and a β axis component isbet of the output alternating current are calculated, and are output to the d-q conversion portion 1004. The d-q conversion portion 1004 inputs the signals COS and SIN which are calculated by the synchronous phase signal calculation portion CALC1, in addition to isalp and isbet, and performs the d-q coordinate conversion of the output alternating current, and calculates a d axis component isd and a q axis component isq. The d axis component isd is output to the subtraction portion 1015, and the q axis component isq is output to the subtraction portion 1014.

In the subtraction portion 1015, a deviation between d axis current command values isdref and isd that are calculated by the direct current voltage control calculation portion CALC4 described later, is calculated, and a difference thereof is output to the PI control portion 1016. Meanwhile, in the subtraction portion 1014, a deviation between 0 being the q axis current command value and isq is calculated, and a difference thereof is output to the PI control portion 1017. The PI control portions 1016 and 1017 calculate alternating current output voltage command values vdref and vqref of the solar inverter 1 on the d-q coordinate so as to reduce the deviation on the basis of the input current deviation, and output the values vdref and vqref to the inverse d-q conversion portion 1018.

In the inverse d-q conversion portion 1018, the signals COS and SIN which are calculated by the voltage command value and the synchronous phase signal calculation portion CALC1 are input, and an α axis component valp and a β axis component vbet of the alternating current output voltage command value are calculated in accordance with Equation 4.

$$[ \begin{matrix}valp \\ vbet\end{matrix} ] = [ \begin{matrix}cos & - sin \\ sin & cos\end{matrix} ] [ \begin{matrix}vdref \\ vqref\end{matrix} ] \qquad Equation 4$$

valp and vbet are output to the two phases-three phases conversion portion 1019, and the conversion portion 1019 calculates alternating current voltage command values vu_ref, vv_ref, and vw_ref in accordance with Equation 5, and the calculated command values are output to the inverter gate signal calculation portion CALC3.

$$[ \begin{matrix}{vu}_{—} ref \\ {vv}_{—} ref \\ {vw}_{—} ref\end{matrix} ] = [ \begin{matrix}1 & 0 \\ - \frac{1}{2} & \frac{\sqrt{3}}{2} \\ - \frac{1}{2} & - \frac{\sqrt{3}}{2}\end{matrix} ] [ \begin{matrix}valp \\ vbet\end{matrix} ] \qquad Equation 5$$

The inverter gate signal calculation portion CALC3 is configured by a carrier wave generation portion 1023, a PWM calculation portion 1020, and a gate control portion 1022.

The carrier wave generation portion 1023 calculates a carrier wave tri being a chopping wave that has a frequency which is equal to a switching frequency of the power conversion portion 2X, and output the carrier wave tri to the PWM calculation portion 1020. The PWM calculation portion 1020 inputs alternating current voltage command values vu_ref, vv_ref, and vw_ref being output signals from the alternating current control calculation portion CALC2, in addition to tri, and calculates the gate signal by comparing the alternating current voltage command value and the transport wave tri in large and small size. Here, a method for calculating the gate signal will be described by using the U phase as an example.

When the phase voltage command value vu_ref is equal to or larger than tri, the gate signal of the IGBT module 2m is turned on, and the gate signal of the IGBT module 2p is turned off. On the contrary, when the voltage command value vu_ref is smaller than tri, the gate signal of the IGBT module 2m is turned off, and the gate signal of the IGBT module 2p is turned on. By the calculation, it is possible to output a pulse voltage where an instant average voltage responds to the voltage command value vu_ref to an alternating current output terminal U of the power conversion portion 2X. Since a V phase and a W phase similarly calculate the gate signal, the overlapped description will be omitted. The gate signals of the IGBT modules 2m to 2r which are calculated by the PWM calculation portion 1020, are output to the gate control portion 1022.

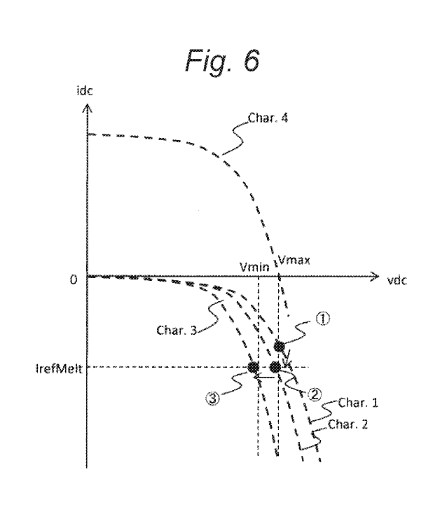

The gate control portion 1022 inputs the gate signal permission signal GateDB being the output of the system control portion 1021, in addition to the gate signal. When the gate signal permission signal GateDB is 0, that is, the nonpermission, all gate signals GateSignals becomes an off command. When the gate signal permission signal GateDB is 1, that is, the permission, the output of the PWM calculation portion 1020 is output to the IGBT modules 2m to 2r within the power conversion portion 2X as a gate signal as it is. As described above, when the gate signal permission signal GateDB is 1 by the alternating current control calculation portion CALC2 and the inverter gate signal calculation portion CALC3, it is possible to control the power conversion portion 2X so as to adjust the alternating current in accordance with the current command value. The system control portion 1021 outputs GateSignals that performs a switching command to IGBT which is arranged in the power conversion portion 2A, Cnt_4SW that performs an opening and closing command of the contactor 4SW, and Cnt_5SW that performs an opening and closing command of the contactor 5SW, as an operator. An specific operation of the system control portion 1021 will be described later while using FIG. 6.

Next, the direct current voltage control calculation portion CALC4 which becomes a characteristic of the solar inverter 1 in the embodiment will be described.

The direct current voltage control calculation portion CALC4 includes a maximum power point tracking control calculation portion 1006 that calculates a direct current voltage command value VdcrefMPPT for maximizing the power which is generated from the strings 60a and 60b when solar radiation is given, a direct current control portion 1008 that calculates a direct current voltage command value VdcrefDCACR based on the current command value IrefMelt which is input to the strings 60a and 60b by the human interface circuit 200, a snow melting run finish determination portion 1009a, a timer 1009b, a calculation portion 1010, a voltage command switching portion 1011 that switches between the direct current voltage command values VdcrefMPPT and VdcrefDCACR by inputting the snow melting run valid flag FLG_SnowMelt which is input by the human interface circuit 200, and a direct current voltage control portion 1013 that calculate the d axis current command value isdref of the power conversion portion 2X so as to reduce the deviation between a direct current voltage command value vdcref and a direct current voltage detection value.

First, an operation of CALC4 in the power generating mode will be described.

In the run command when the power generating run is carried out, the flag FLG_SnowMelt from the human interface circuit 200 becomes 0. Therefore, the output of the logical product calculation portion 1010 becomes 0 regardless of the output of the timer 1009b, and VdcrefMPPT is input to the direct current voltage command switching portion vdcref. Furthermore, VdcrefMPPT is a value which is calculated by the maximum power point tracking control calculation portion 1006, so as to maximize the direct current input power being a product of a direct current voltage detection value vdc and an input direct current detection value idc. Since a method for maximizing the generated power is the calculation which is frequently used in the technology field, the description thereof will be omitted.

Next, a case where the snow melting run is carried out will be described.

The input direct current detection value idc, and the current command value IrefMelt at the time of the snow melting are input to the subtraction portion 1007. Here, since being a current which flows to the strings 60a and 60b from the solar inverter 1, the current command value IrefMelt becomes a negative value. An absolute value of IrefMelt is set to be a value which is smaller than the sum of the rated current values of each of the strings, from the viewpoint of the protection of the strings 60a and 60b.

The subtraction portion 1007 calculates a difference Δidc between IrefMelt and idc, and Δidc is input to the direct current control portion 1008 and the snow melting run finish determination portion 1009a.

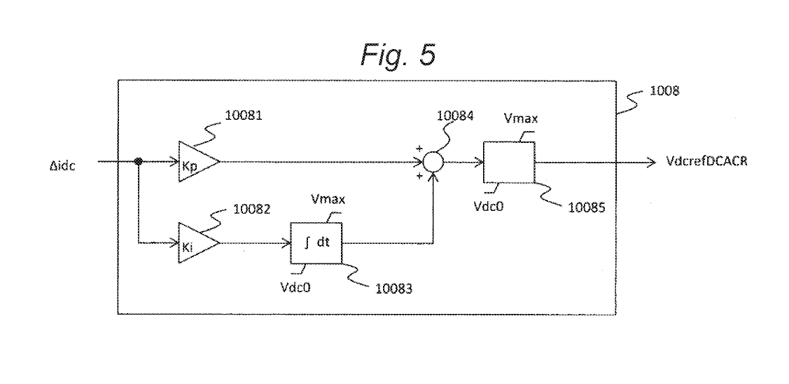

The configuration of the direct current control portion 1008 will be described by using FIG. 5. FIG. 5 is a block diagram of the direct current control portion of the solar inverter in the first embodiment. The direct current control portion 1008 includes a proportional gain calculation portion 10081, an integral gain calculation portion 10082, an integral portion 10083, an addition portion 10084, and an upper limit and lower limit limiter 10085. The proportional gain calculation portion 10081 inputs the difference Δidc, and calculates a value by performing the constant multiplication of the input, and outputs the value to the addition portion 10084. The integral gain calculation portion 10082 performs the constant multiplication of the difference Δidc, and outputs the output thereof to the integral portion 10083 with the upper limit and the lower limit. The output of the integral portion 10083 is output to the addition portion 10084. The addition portion 10084 adds the outputs of the proportional gain calculation portion 10081 and the integral portion 10083 with the upper limit and the lower limit, and outputs the sum thereof to the upper limit and lower limit limiter 10085. The upper limit and lower limit limiter 10085 limits the signal which is input from the addition portion 10084 so as to be equal to or smaller than Vmax being a predetermined upper limit value, and to be equal to or larger than Vmin being a predetermined lower limit value, and outputs the output as the voltage command value VdcrefDCACR for the current control. An output lower limit value Vdc0 of the direct current control portion 1008 is the lowest voltage which is necessary to interconnect to the power system 3 without overmodulation, and the output voltage upper limit value Vmax is the maximum value of the supplied voltage for protecting the strings 60a and 60b from the overvoltage. If Vmax is set into a high value, the strings may be damaged. Moreover, if Vmax is too low, the current which is supplied for the snow melting may not be supplied. Therefore, it is preferable that Vmax is at a degree of the voltage when the terminals of the strings 60a and 60b at the time of the rated solar radiation are open.

On returning to FIG. 3, the description of the calculation of CALC4 at the time of the snow melting run is continued. When idc is large with respect to IrefMelt, that is, when the current which is supplied to the strings 60a and 60b from the solar inverter 1 is large, the value of Δidc becomes large, and the output of the direct current control portion 1008 is increased.

The output VdcrefDCACR of the direct current control portion 1008 becomes the direct current voltage command value vdcref of the solar inverter 1, and is output to the subtraction portion 1012, through the voltage command switching portion 1011.

The subtraction portion 1012 calculates the deviation between the direct current voltage detection value vdc and the direct current voltage command value vdcref, and outputs the deviation to the direct current voltage control portion 1013.

The direct current voltage control portion 1013 is a PI control portion, and calculates the active current command value isdref, so as to reduce the deviation of the input direct current voltage.

When the current which is supplied to the strings 60a and 60b from the solar inverter 1 is small, the increase of the output of the direct current control portion 1008 is continued, but the output is limited by the upper limit value Vmax.

The deviation Δidc of the direct current is input to the snow melting run finish determination portion 1009a. The snow melting run finish determination portion 1009a compares the absolute value of Δidc with Δidc_TH being a predetermined value, and if the absolute value of Δidc is smaller than Δidc_TH, 1 is output to the timer 1009b, and if the absolute value of Δidc is larger than Δidc_TH, 0 is output to the timer 1009b. Here, Δidc_TH is a small value sufficiently with respect to IrefMelt, and for example, is set to be approximately 5% of the absolute value of IrefMelt. The timer 1009b outputs 0 in a case where the time when the output of the snow melting run finish determination portion 1009a is 1 by being continued exceeds a predetermined time Tmelt, and 1 in other cases as an output signal FLG_END, to the logical product calculation portion 1010 and the human interface circuit 200.

FLG_END which is input from the controller 100 becomes 0, and thereby, the human interface circuit 200 determines materialization of a snow melting finish condition, and makes FLG_SnowMelt being the output to the controller 100 into 0. FLG_END is transmitted to the high order control apparatus which is not illustrated in the drawing, and the control apparatus makes the run command COM_Run to the solar inverter 1 into 0. Thereby, the solar inverter 1 stops the operation.

Next, an operation point of the strings 60a and 60b at the time of the snow melting run will be descried by using FIG. 6.

FIG. 6 is a view for illustrating current-voltage characteristics of the solar panel, and the operation point of the solar inverter in the first embodiment. A horizontal axis illustrates a terminal voltage of the string, and a vertical axis illustrates a total value of the current which is output from the string.

When the deep snow is on the panel, since the temperature of the panel is low, the characteristic of the string becomes V-I characteristic which is illustrated as Char. 1. The current supply from the solar inverter 1 is started by the snow melting run (operation point (1)). Since the impedance of the string is large, the voltage which is supplied from the solar inverter 1 becomes the upper limit value Vmax. If the current from the solar inverter 1 flows, the impedance of the string is lowered, and V-I characteristic is changed so as to be Char. 2, and the current which is determined as IrefMelt is capable of being supplied from the solar inverter 1 (operation point (2)).

If the time elapses, the temperature of the string is further increased, and V-I characteristic is changed so as to be Char. 3, and the current that is equal to IrefMelt being the command value is capable of being supplied, even when the voltage which is lower than Vmax is supplied (operation portion (3)). Furthermore, V-I characteristic of Char. 4 is V-I characteristic of the strings 60a and 60b when a quantity of the rated solar radiation is given.

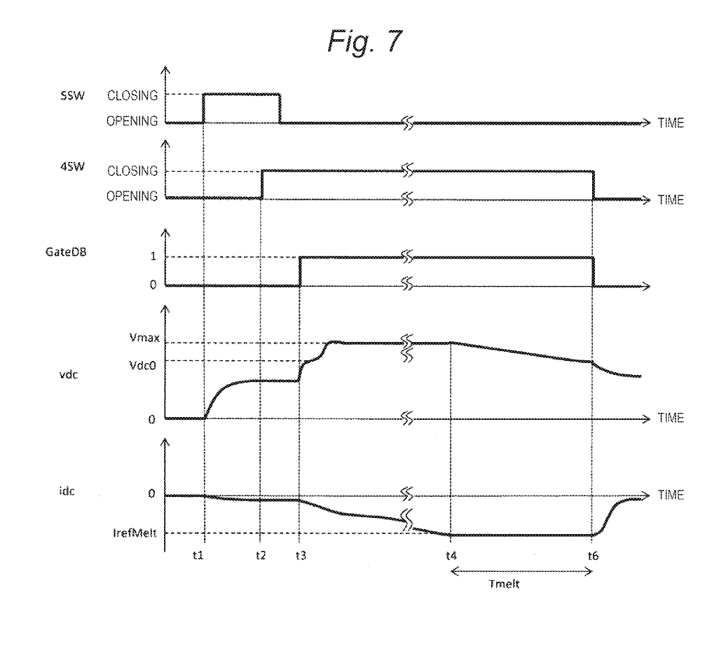

By using FIG. 7, the operation of the solar inverter 1 will be described in time series. FIG. 7 is a time chart of the solar inverter in the first embodiment. The horizontal axis is the elapsed time, and the vertical axes are an opening and closing state of the contactor 5SW, an opening and closing state of the contactor 4SW, the gate signal permission signal GateDB, the direct current voltage vdc, and the input direct current idc in sequence from the top.

At the time t1, the run command COM_RUN from the high order control apparatus which is not illustrated in the drawing is changed into the run command, and the contactor 5SW is inserted. Thereby, since the direct current capacitor 2C is charged from the power system 3, vdc is increased.

At the time t2 when the predetermined time elapses after the contactor 5SW is inserted, the contactor 4SW is inserted. Thereby, the solar inverter 1 is connected to the power system 3 in the state where a limit resistor 5R is short-circuited.

In this manner, from inserting the contactor 5SW until inserting the contactor 4SW, by leaving the time as the predetermined time, it is possible to insert the contactor 4SW after the charging of the direct current capacitor 2C is finished, and it is possible to avoid an inrush current from the power system 3. After Cnt_4SW is changed into a closing command, the system control portion 1021 changes Cnt_5SW into an opening command. In this manner, by making the contactor 5SW open, it is prepared at the next time of starting up the solar inverter 1. At the time t3, the gate signal permission signal GateDB becomes 1 from 0, and the switching of IGBT module is started. For example, t3 is the timing when a precharging of the direct current capacitor is finished through the resistor 5R. When the direct current is equal to Vdc0, since the current which is supplied to the strings 60a and 60b from the solar inverter 1 is small in comparison with IrefMelt, the direct current voltage command value vdcref is corrected into a high value by the direct current control portion 1008, and is increased to the upper limit value Vmax.

The solar inverter 1 maintains the direct current voltage in the state of Vmax until the input direct current idc and IrefMelt agree with each other.

After the time t4, the temperatures of the strings 60a and 60b are increased, and thereby, since the impedance of the string is lowered, the direct current voltage vdc is slightly lowered.

At the time t6 when a period in which the deviation between the input direct current idc and the current command value IrefMelt is equal to or smaller than Δidc_TH, elapses Tmelt, the controller 100 transmits the materialization of the snow melting run finish condition to the human interface circuit 200 by making FLG_END into 0. Therefore, the human interface circuit 200 makes FLG_SnowMelt into 0. Moreover, the high order control apparatus makes COM_Run into 0, and stops the inverter. Here, it is possible to randomly determine Tmelt by a user, and it is possible to determine Tmelt with consideration for the power quantity which is given per one sheet of panel.

By the stop command, the gate signal permission signal GateDB is changed into 0, and the operation signal Cnt_4SW of the contactor 4SW is changed into the opening command, and the solar inverter 1 stops the run. If the solar inverter 1 stops the run, since the power supply from the power system 3 is vanished, the voltage between the terminals of the direct current capacitor 2C is lowered, and the snow melting voltage is also reduced along therewith. As described above, the solar inverter 1 may realize the snow melting run.

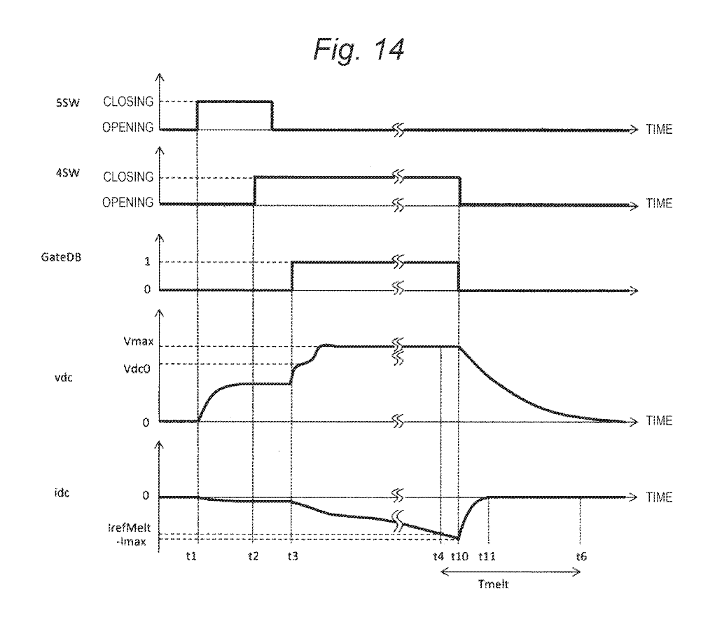

Here, in order to describe that the sufficient heat quantity for the snow melting may be supplied to the strings 60a and 60b by the embodiment, an operation waveform in a case where a fixed voltage is supplied to the strings 60a and 60b at the time of the snow melting run, is illustrated in FIG. 14.

The voltage which is supplied to the strings 60a and 60b from the solar inverter 1, is assumed to be Vmax in the same manner as the embodiment.

The start-up of the solar inverter 1, and a behavior before the snow melting current arrives at Irefmax are equal to the operations of the solar inverter 1 in the embodiment.

At the time t4, the snow melting current agrees with IrefMax, but in the related art example, since the voltage which is supplied to the strings 60a and 60b is fixed, the increase of the current is continued.

At the time t10, the current arrives at an overcurrent level (−Imax) of the strings 60a and 60b, and the solar inverter 1 of the related art example stops the snow melting run. Since the power is not supplied to the solar inverter 1 from the power system 3 so that the solar inverter 1 stops the snow melting run, the voltage of the direct current capacitor 2C of the inverter is lowered.

Along with the lowering of the direct current voltage, the current which is supplied to the strings 60a and 60b is reduced, and becomes 0 at the time t11.

Therefore, in the solar inverter 1 according to the aspect of the present invention, the supply of the fixed current is continued until the time t6, and on the other hand, in the related art example, the period in which the snow melting current may be supplied becomes short. As a result, it is possible to supply the heat quantity which is sufficient for melting the snow on the solar panel.

In the embodiment, the current command IrefMelt at the time of the snow melting mode is the value which is output by the human interface circuit 200, but may be a parameter which the controller 100 may change through a fixed value or a maintenance interface. Moreover, the snow melting mode of the solar panel may be operated not only by using the power of the power system, but also by using other power sources (for example, storage battery).

According to the present invention, when the snow melting run command is sent by the operating person, it is possible to increase the current for the snow melting, without supplying the excessive voltage to the strings 60a and 60b, and it is possible to maintain the run in the solar inverter in the state of being electrified by a predetermined current. Thereby, since it is possible to supply the sufficient heat quantity to the string while protecting the string from the overvoltage and the overcurrent, it is possible to effectively perform the snow melting of the snow on the solar panel.

### Second Embodiment

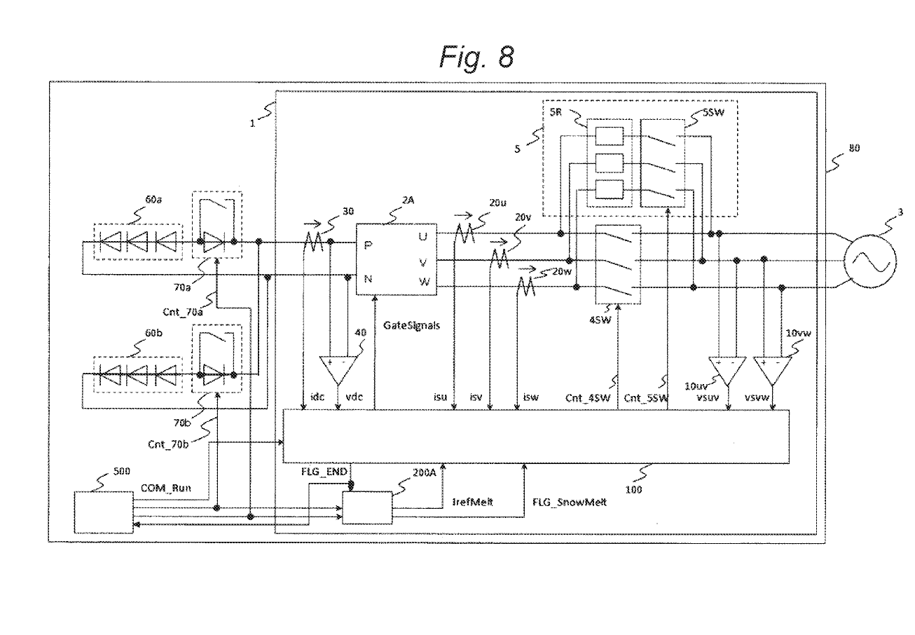

A second embodiment of the present invention will be described by using FIG. 8. FIG. 8 is an overview of a photovoltaic system in the second embodiment.

The difference between the second embodiment and the first embodiment of the present invention, is a point in which the photovoltaic system 80 includes an integrated control portion 500, or blocking diode circuits 70a and 70b instead of the fuses 50a and 50b are included in the strings 60a and 60b.

When a plurality of strings are connected in parallel, there is a case where a blocking diode is included as a purpose of preventing the inflow of a fault current from other strings at the time of generating a short-circuit fault within the string. The embodiment presents the photovoltaic system 80 that may realize the snow melting run even when the above diode is included.

In the photovoltaic system 80 illustrated in FIG. 8, components which are the same as the photovoltaic system 80 according to the first embodiment are designated by the same numbers, and the overlapped description will be omitted.

The integrated control portion 500 outputs operation signals Cnt_70a and Cnt_70b for operating the opening and closing of the blocking diode circuits 70a and 70b. The operation signals Cnt_70a and Cnt_70b are also input to a human interface circuit 200A, in parallel to the blocking diode circuits 70a and 70b.

The blocking diode circuits 70a and 70b include a blocking diode, and a contactor which is connected to the diode in parallel.

When the snow melting run is carried out, the integrated control portion 500 outputs the operation signal for inserting the contactor within the blocking diode circuit of the string which supplies the snow melting current.

The difference between the human interface circuit 200A and the human interface circuit 200 of the first embodiment, is a point of inputting Cnt_70a and Cnt_70b, calculating the snow melting current command value IrefMelt which becomes an insertion command from the number of contactors, and outputting the value to the controller 100. The reason why the snow melting current command value IrefMelt is calculated from the number of contactors is as follows. When the contactors are partially disconnected by a breakdown of the panel or the like, if the rated current of the whole panel is supplied from the inverter, the current flowing through the panel becomes large in comparison with the rated current, and as a result, there is the possibility that the panel is hurt. By determining the current command value (IrefMelt) at the time of the run in the snow melting mode based on the number of inserting of the contactor, it is possible to supply the current which is equivalent to the rated current of the panel from the solar inverter, to the panel where the contactor is inserted as described above, and it is possible avoid the damage by the overcurrent electrification of the panel.

In the same manner as the first embodiment, the solar inverter 1 carries out the snow melting run, and FLG_ENG indicating the materialization of the snow melting run finish condition is output the human interface circuit 200A, and the integrated control portion 500. If FLG_ENG of the materialization of the snow melting run finish condition is input to the integrated control portion 500, the contactor operation signal of the blocking diode circuit of the string which supplies the snow melting current, is open. Thereby, at the time of the normal power generating, it is possible to prevent the fault which is generated in the string from spreading to the other strings by the blocking diode.

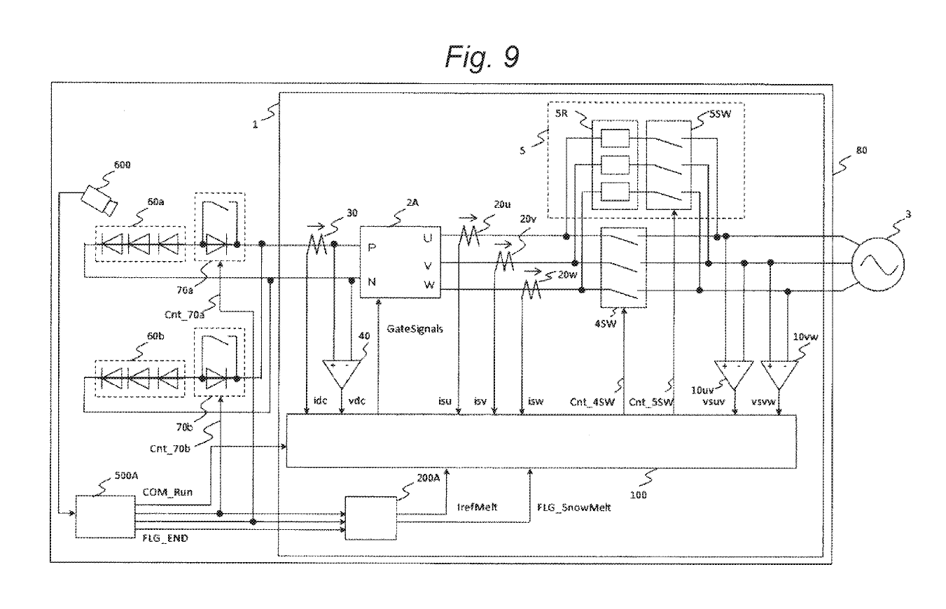

In the embodiment, the configuration in which the snow melting run is finished by the flag FLG_END from the controller 100 is illustrated, but as illustrated in FIG. 9, a camera 600 that captures an image in a portion or all of the solar panel is included, and the snow melting state is analyzed by the integrated control portion 500A with the image data of the camera, and the snow melting run may be finished.

According to the embodiment, it is possible to increase the current for the snow melting, without supplying the excessive voltage to the strings 60a and 60b, and it is possible to maintain the run in the solar inverter in the state of being electrified by the predetermined current. Thereby, since it is possible to supply the sufficient heat quantity to the string while protecting the string from the overvoltage and the overcurrent, it is possible to effectively perform the snow melting of the snow on the solar panel.

Furthermore, by including the integrated control portion 500, the snow melting current may flow to the string even when the blocking diode is included in the string, or it is possible to prevent the excessive current from flowing to the string in order to adjust the snow melting current which is supplied from the solar inverter 1 based on the information of the string where the snow melting current flows.

### Third Embodiment

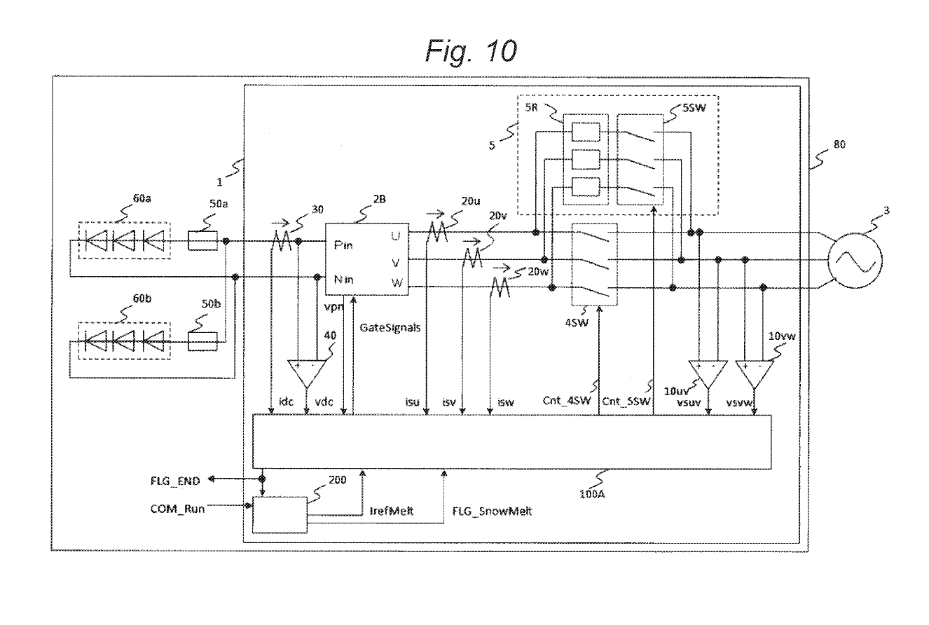

A third embodiment of the present invention will be described by using FIG. 10. FIG. 10 is an overview of a photovoltaic system in the third embodiment.

The difference between the third embodiment and the first embodiment, is a point in which a power conversion portion 2B of the solar inverter 1 is configured by the inverter 2X, and a chopper 2Y.

The chopper 2Y is capable of adjusting the voltage which is supplied to the strings 60a and 60b at very high speed, by changing a duty ratio of the IGBT module. Moreover, since it is possible to supply the voltage which is lower than the output lower limit value Vdc0 of the inverter 2X to the string, it is possible to widen a selection range of the string.

Hereinafter, the details thereof are written. Here, the components which are the same as the first embodiment are designated by the same signs, and the overlapped description will be omitted.

The power conversion portion 2B which is included in the solar inverter 1 of the photovoltaic system 80 in the second embodiment, is configured by the chopper 2Y, and the inverter 2X.

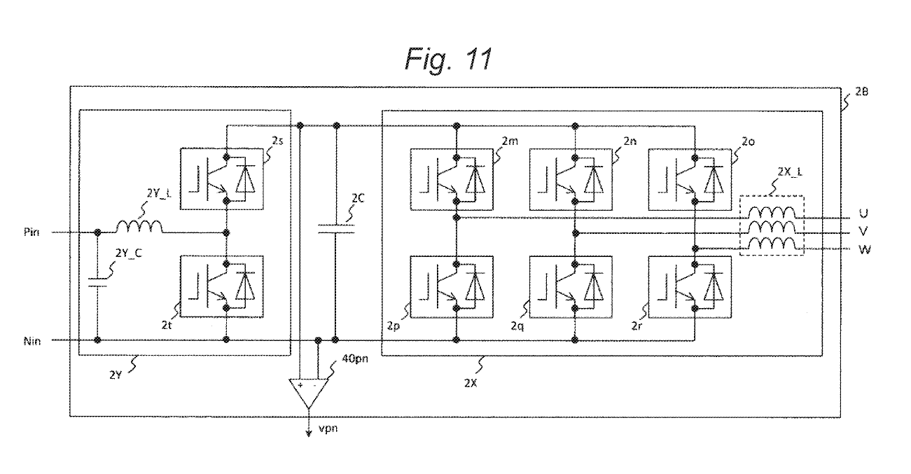

The configuration of the main circuit of the power conversion portion 2B is illustrated in FIG. 11.

The chopper 2Y is connected to the direct current circuit of the inverter 2X, in parallel to the direct current capacitor 2C.

The chopper 2Y is configured by the IGBT modules 2s and 2t, a filter reactor 2Y_L, and a filter capacitor 2Y_C. At the time of the power generation, the chopper 2Y supplies the direct current power which is obtained from the strings 60a and 60b by performing the increase operation, to the inverter 2X.

The inverter 2X carries out the power control of the power system 3 so that an inner direct current voltage vpn which is detected by a voltage sensor 40pn agrees with the command value. As described above, the generated power which is obtained from the strings 60a and 60b is transmitted to the power system 3.

Meanwhile, when the snow melting run is carried out, the chopper 2Y uses the inverter 2X as a direct current power source, and controls the output voltage vdc so that the snow melting current IrefMelt flows.

The gate signal of the IGBT modules 2s and 2t of the chopper 2Y, is calculated by a controller 100A.

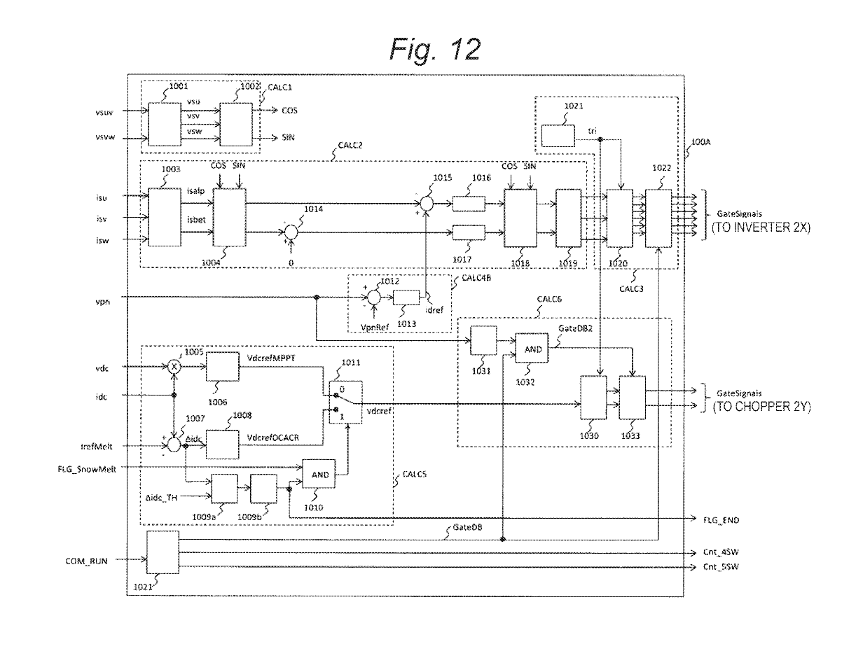

The configuration and the calculation of the controller 100A will be described by using FIG. 12.

By being broadly divided, the controller 100A is configured by the synchronous phase signal calculation portion CALC1 that calculates the sine wave in synchronization with the interconnection point voltage phase, the alternating current control calculation portion CALC2 that calculates the alternating current voltage command value for controlling the output alternating current of the solar inverter 1 in accordance with the command value, the inverter gate signal calculation portion CALC3 that calculates the gate signal GateSingals of the inverter 2X by PWM-modulating the alternating current voltage command value which is calculated by CALC2, a direct current voltage control calculation portion CALC4B that calculates the command value of the active current which is output to the alternating current side of the solar inverter 1 in order to control the direct current voltage, the system control portion 1021 that calculates the operation signals Cnt_4SW and Cnt_5SW of the contactors 4SW and 5SW, and the gate signal permission signal GateDB, based on the run command COM_Run that is input from the high order control apparatus which is not illustrated in the drawing, a direct current voltage command value calculation portion CALC5 that calculates the direct current voltage command value which is output to the side of the strings 60a and 60b, and a chopper gate signal calculation portion CALC6 that calculates the gate signals GateSignals of the chopper 2Y by PWM-modulating the output voltage command value vdcref which is calculate by CALC5. Since CALC1, CALC2 and CALC3 are the same calculation portions as the first embodiment, the description thereof will be omitted.

In the direct current voltage control calculation portion CALC4B, the voltage vpn between the terminals of the direct current capacitor 2C is input, and the deviation between the voltage and a direct current voltage command value VpnRef is calculated by the subtraction portion 1012, and in order to reduce the deviation, a d axis current command value idref that is the output of the inverter 2X by the voltage control portion 1013 being the PI control portion is calculated. idref is output to CALC2, and the inverter 2X calculates the alternating current output voltage command value so that the d axis current agrees with idref.

In the direct current voltage command value calculation portion CALC5, the direct current voltage command value VdcrefMPPT for maximizing the generated power of the strings 60a and 60b, and the direct current voltage command value VdcrefDCACR for agreeing the direct current which is supplied to the strings 60a and 60b from the solar inverter 1 at the time of the snow melting run with the command value, are calculated, in the same manner as the direct current voltage control calculation portion CALC4 of the first embodiment.

Since the calculation of the determining of the snow melting run finish condition is the same as the first embodiment, the description thereof will be omitted. In the configurations of the first embodiment and the second embodiment, there is a need to set the output lower limit value of the direct current control portion 1008 into the lowest voltage Vdc0 which is determined by the voltage of the power system 3. However, according to the embodiment, it is possible to lower the output voltage down to 0V by changing the duty ratio of the chopper, and it is possible to widen the types of the solar panels and the numbers of series which are used in the strings 60a and 60b, in comparison with the first embodiment and the second embodiment.

Moreover, in the configurations of the first embodiment and the second embodiment, it ought to wait for the response of a voltage control system of the capacitor 2C in order to change the direct current voltage which is supplied to the strings 60a and 60b. However, since it is possible to quickly change the direct current voltage vdc only by changing the duty ratio of the chopper 2Y in the embodiment, the high-speed current control is possible.

The output of the direct current voltage command value calculation portion CALC5, and the inner direct current voltage detection value vpn are input to the chopper gate signal calculation portion CALC6.

The inner direct current voltage detection value vpn is input to a direct current voltage settling determination portion 1031, and the determination portion 1031 determines whether the inner direct current voltage is maintained into a predetermined value, and outputs 1 in the case where the inner direct current voltage is maintained into the predetermined value, and 0 in other cases, to a logical product calculation portion 1032.

The logical product calculation portion 1032 inputs the output of the direct current voltage settling determination portion 1031, and the gate signal permission signal GateDB, and outputs a logical product thereof to the gate control portion 1033.

Meanwhile, the direct current voltage command value vdcref which is calculated by CALC5, is input to the PWM calculation portion 1030, and the PWM calculation portion 1030 calculates the gate signals of the IGBT modules 2s and 2t by comparing the carrier wave tri and vdcref in large and small size, and outputs the signals to the gate control portion 1033.

When the output of the logical product calculation portion 1032 is 1, the gate control portion 1033 outputs the output of the PWM calculation portion 1030 as a gate signal of the chopper 2Y, to the IGBT modules 2s and 2t. When the output of the logical product calculation portion 1032 is 0, the off command is continuously output to the IGBT modules 2s and 2t.

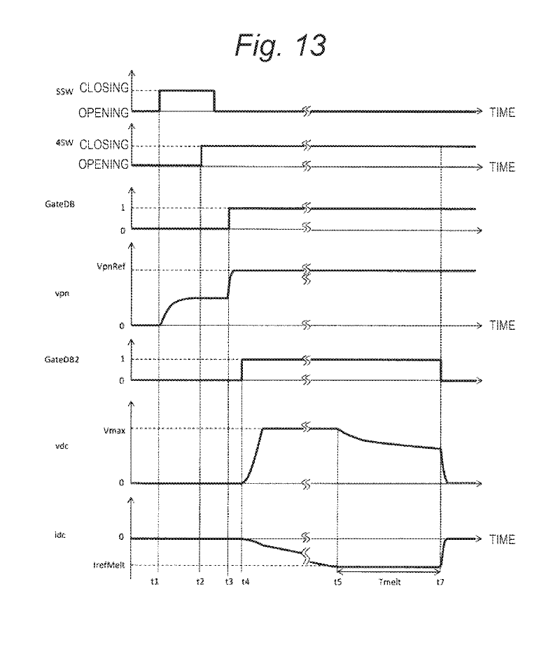

FIG. 13 is a time chart of the solar inverter in the third embodiment.

At the time t1, if the run start command COM_Run is input, the system control portion 1021 sequentially inserts the contactor 5SW at the time t1, and the contactor 4SW at the time t2, in the same manner as the first embodiment. At the time t3, the system control portion 1021 starts the run of the inverter 2X by changing the gate signal permission signal GateDB into 1 from 0. The inverter 2x controls the d axis current so that the inner direct current voltage vpn and the command value VpnRef agree with each other.

The inner direct current voltage vpn is input to the direct current settling determination portion 1031, and vpn is determined by being set to VpnRef, and at the time t4, 1 is output to the logical product calculation portion 1032. Thereby, the gate signal permission signal GateDB2 of the chopper 2Y is changed into 1 from 0, and the chopper 2Y starts the run.

By the direct current control portion 1008, the output voltage command value vdcref of the chopper 2Y is calculated so that the input direct current idc and the snow melting current command value IrefMelt agree with each other, and as a result, vdc is increased up to the upper limit value Vmax.

At the time t5, idc and IrefMelt agree with each other, and the solar inverter 1 continues the supply of the snow melting current to the strings 60a and 60b until the time t7 when the timer 1009b is operated.

At the time t7, the timer 1009b outputs FLG_END which transmits the materialization of the snow melting run finish condition to the human interface circuit 200, and the human interface circuit 200 makes FLG_SnowMelt into 0. Moreover, the high order control apparatus makes COM_Run into 0 by inputting FLG_END, and stops the solar inverter 1, and outputs the operation signal Cnt_4SW for making the contactor 4SW open.

As described above, according to the first embodiment, when the snow melting run command is sent by the operating person, it is possible to increase the current for the snow melting, without supplying the excessive voltage to the strings 60a and 60b, and it is possible to maintain the run in the solar inverter in the state of being electrified by the predetermined current. Thereby, since it is possible to supply the sufficient heat quantity to the string while protecting the string from the overvoltage and the overcurrent, it is possible to effectively perform the snow melting of the snow on the solar panel.

Furthermore, according to the second embodiment, it is possible to widen the range of the direct current voltage which may be supplied to the strings 60a and 60b, and it is possible to widen the characteristics of the solar panel, and choices of the number of series in the string. Moreover, according to the third embodiment, since the change of the direct current voltage which is supplied to the strings 60a and 60b is adjustable at higher speed by changing the duty ratio of the chopper 2Y, it is possible to perform the current control at higher speed.

What is claimed is:

1. A power conversion apparatus which is connected between a solar panel and a power system, comprising:
a power generating mode that converts a generated power of the solar panel into an alternating current power; and
a snow melting mode that heats the solar panel by obtaining the power from the power system, and supplying the power to the solar panel,
wherein at the time of the snow melting mode, a voltage which is output to the solar panel is controlled such that a first current value being a value where a current that is supplied to the solar panel from the power conversion apparatus is smaller than an overcurrent level of the solar panel flows in a predetermined period.

2. The power conversion apparatus according to claim 1,
wherein when the power conversion apparatus is run in the snow melting mode, the run of the snow melting mode is finished at the time of a state where a deviation between the current which is supplied to the solar panel from the power conversion apparatus and the first current value is within a predetermined range while a predetermined time elapses.

3. The power conversion apparatus according to claim 1, further comprising:
a self-excitation type inverter of at least one,
wherein the self-excitation type inverter includes a semiconductor switching element and a direct current capacitor, and
the direct current capacitor is charged from the power system before the semiconductor switching element is PWM-controlled.

4. The power conversion apparatus according to claim 1,
wherein the solar panel includes a plurality of strings that are connected in series, a blocking diode that is arranged between the string and a bidirectional converter, and an electromagnetic contact portion that is connected to the blocking diode in parallel, and
the first predetermined current value is determined based on the number of inserting of the electromagnetic contact portion.

5. The power conversion apparatus according to claim 1, further comprising:
a camera that captures an image in at least a portion of the solar panel,
wherein the snow melting mode is finished by analyzing a snow melting state on the solar panel based on the captured image of the camera.

6. The power conversion apparatus according to claim 1, further comprising:
a self-excitation type inverter; and
a chopper.

7. The power conversion apparatus according to claim 1,
wherein the power conversion apparatus is a bidirectional converter.

8. A photovoltaic system comprising:
a solar panel; and
a power conversion apparatus that is connected between the solar panel and a power system,
wherein the power conversion apparatus includes a power generating mode that converts a generated power of the solar panel into an alternating current power, and a snow melting mode that heats the solar panel by obtaining the power from the power system, and supplying the power to the solar panel, and
at the time of the snow melting mode, the power conversion apparatus controls a voltage which is output to the solar panel such that a first current value being a value where a current that is supplied to the solar panel from the power conversion apparatus is smaller than an overcurrent level of the solar panel flows in a predetermined period.

9. The photovoltaic system according to claim 8, further comprising:
an interface that changes the first predetermined current value.
